(19) United States
(12) Patent Application Publication
(10) Pub. No.: US 2025/0270435 A1
(43) Pub. Date: Aug. 28, 2025

(54) BORON NITRIDE POWDER, METHOD FOR PRODUCING SAME, AND HEAT-DISSIPATING SHEET

(71) Applicant: Denka Company Limited, Tokyo (JP)

(72) Inventors: Eiji INUKAI, Chuo Tokyo (JP); Fukumasa KATO, Chuo Tokyo (JP); Go TAKEDA, Chuo Tokyo (JP); Haruka TATEOKA, Chuo Tokyo (JP)

(21) Appl. No.: 18/857,807

(22) PCT Filed: Apr. 13, 2023
(86) PCT No.: PCT/JP2023/015037

§ 371 Date: Oct. 17, 2024

(30) Foreign Application Priority Data
Apr. 21, 2022 (JP) 2022-069926

(51) Int. Cl. C09K 5/14; C01B 21/064; C08K 7/00

(52) U.S. Cl. CPC C09K 5/14; C01B 21/0645; C01B 21/0648; C08K 7/00; C01P 2002/76; C01P 2004/20; C01P 2004/61; C01P 2006/11; C01P 2006/12; C01P 2006/32

(57) ABSTRACT

An aspect of the present disclosure provides a boron nitride powder including primary particles of hexagonal boron nitride each having a scale shape, in which an average particle diameter is 4.0 to 7.0 μm, a BET specific surface area is 3.0 m²/g or less, and a graphitization index is 1.2 or less.

### TECHNICAL FIELD

The present disclosure relates to a boron nitride powder, a method for producing the same, and a heat-dissipating sheet.

### BACKGROUND ART

In electronic components such as transistors, thyristors, and CPUs, it is an important problem to efficiently dissipate heat generated during use. Therefore, a heat-dissipating member having high thermal conductivity is used together with such an electronic component. On the other hand, boron nitride particles have high thermal conductivity and highly insulating properties, and are thus widely used as a filler material in heat-dissipating members.

For example, Patent Literature 1 proposes a hexagonal boron nitride powder that can increase a thermal conductivity and withstand voltage (dielectric breakdown voltage) of a resin or the like in a case of being used as a filler material in an insulating heat-dissipating material such as a resin, and a method for producing the same.

In recent years, devices on which electronic components are mounted have become faster in signal transmission and come to have a larger capacity. Therefore, the heat-dissipating member is also required to have characteristics of being capable of coping with the above-described tendency. Specifically, a heat-dissipating member having a small dielectric loss tangent is desirable.

### CITATION LIST

### Patent Literature

Patent Literature 1: Japanese Unexamined Patent Publication No. 2019-116401

### SUMMARY OF INVENTION

### Technical Problem

As a method for reducing a dielectric loss tangent of a heat-dissipating member, for example, it is conceivable to use a resin having a small dielectric loss tangent as a resin to be used. However, a liquid crystalline polymer, a fluororesin, or the like known as a resin with a low dielectric loss tangent has a low dielectric loss tangent, but is insufficient in terms of processability, thermal properties, mechanical properties, and the like in the application. Therefore, from the viewpoint of improving thermal properties, a filler material is generally used. However, in a case where a dielectric loss tangent of a filler material itself is large, low dielectric loss tangent characteristics of a resin may not be sufficiently exhibited due to incorporation of the filler material.

An object of the present disclosure is to provide a boron nitride powder having a low dielectric loss tangent and an excellent filling property in a resin, and a method for producing the same. Also, another object of the present disclosure is to provide a heat-dissipating sheet including the boron nitride powder described above.

### Solution to Problem

An aspect of the present disclosure provides a boron nitride powder including primary particles of hexagonal boron nitride each having a scale shape, in which an average particle diameter is 4.0 to 7.0 μm, a BET specific surface area is 3.0 m²/g or less, and a graphitization index is 1.2 or less.

The boron nitride powder contains primary particles of hexagonal boron nitride having a relatively small particle diameter. The boron nitride powder also contains particles having a small particle diameter, but has a low BET specific surface area. It is considered that the reason why the BET specific surface area remains small is that an outer periphery of the primary particle is smooth and a thickness is large. Here, primary particles of hexagonal boron nitride each having a scale shape have functional groups (for example, a hydroxyl group, an amino group, and the like) on side surfaces ((100) faces), but in a case where an electric field is applied, the electric field can be consumed by vibration of the functional groups, and thus an increase in the number of functional groups can increase the dielectric loss tangent of the boron nitride powder. However, simply increasing the thickness of the primary particles may lead to an increase in a proportion of functional groups, and thus it is desirable to reduce the proportion of the side surfaces of the primary particles. Although it is not easy to quantify the proportion of the side surfaces of the primary particles, as described above, by using the average particle diameter and the BET specific surface area as indices, particles containing primary particles having a relatively large thickness but few irregularities on side surfaces ((100) faces) of particles can be selected. In addition, regarding the average particle diameter and the BET specific surface area, by satisfying requirements of the boron nitride powder according to the present disclosure, the shape of the particles is relatively smooth and the particle diameter is also well-ordered, so that an excellent filling property in the resin can be exhibited. Furthermore, in a case where defects or the like are generated in the primary particles of hexagonal boron nitride and crystallinity is lowered, the defects may inhibit transmission of the electric field and may cause energy consumption, so that the dielectric loss tangent of the boron nitride powder may increase. On the other hand, since the boron nitride powder according to the present disclosure has a graphitization index of a predetermined value or less, the boron nitride powder also has excellent crystallinity and a low dielectric loss tangent.

The boron nitride powder may have a tap density of 0.70 g/cm³ or more. As the thickness of the primary particles of hexagonal boron nitride increases, the tap density also tends to increase. The measurement accuracy of the thickness of the primary particles of hexagonal boron nitride is not higher than the measurement accuracy of the tap density. Therefore, the average particle diameter and the tap density can also be considered as indices of a content proportion of the primary particles having an appropriate thickness. That is, when the boron nitride powder is adjusted so that an average particle diameter is in a predetermined range and an upper limit value of the tap density is within the above range, the proportion of the primary particles having an appropriate thickness is large, and it can be said that the boron nitride powder has both a low dielectric loss tangent and a good filling property in a resin.

Another aspect of the present disclosure provides a heat-dissipating sheet including a resin, and a filler dispersed in the resin, in which the filler contains the boron nitride powder.

Since the heat-dissipating sheet contains the above-described boron nitride powder as a filler, a value of the dielectric loss tangent can be suppressed to be low.

Still another aspect of the present disclosure provides a method for producing a boron nitride powder, including a firing step of firing a raw material powder containing a carbon-containing compound, a boron-containing compound, and a sintering aid under a pressurized nitrogen atmosphere to obtain a fired product containing primary particles of hexagonal boron nitride each having a scale shape, and a pulverization step of crushing the fired product to obtain a powder, in which a content of the boron-containing compound in the raw material powder is 77.0 mass % or less.

In the method for producing a boron nitride powder, since a content of the boron-containing compound in the raw material powder in the firing step is adjusted to be a predetermined value or less, the amount of a liquid phase serving as a growth field of the primary particles of hexagonal boron nitride is adjusted, and an increase in the average particle diameter of the primary particles is suppressed, and the particle diameter is adjusted by promoting the growth in the thickness, and then an aggregate in which the primary particles are loosely associated with each other is crushed by a crushing step, whereby the boron nitride powder as described above can be produced.

In the producing method, the pressure of the atmosphere in the firing step may be 0.9 MPaG or less. By setting a pressure condition in the firing step within the above range and relaxing the degree of pressurization, it is possible to volatilize a liquid phase to the outside of a system during the firing step, to suppress the growth of primary particles of hexagonal boron nitride in an a-axis direction, and to further suppress the increase in the average particle diameter.

### Advantageous Effects of Invention

An object of the present disclosure is to provide a boron nitride powder having a low dielectric loss tangent and an excellent filling property in a resin, and a method for producing the same. Also, another object of the present disclosure is to provide a heat-dissipating sheet including the boron nitride powder described above.

### BRIEF DESCRIPTION OF DRAWINGS

FIG. 1 is a schematic view illustrating an example of a heat-dissipating sheet.

FIG. 2 is a cross-sectional view taken along line II-II of FIG. 1.

### DESCRIPTION OF EMBODIMENTS

Hereinafter, embodiments of the present disclosure will be described with reference to the drawings as the case may be. However, the following embodiments are examples for describing the present disclosure, and are not intended to limit the present disclosure to the following contents. In the description, the same reference numerals are used for the same elements or elements having the same functions, and redundant description is omitted as the case may be. Further, unless otherwise specified, the positional relationship such as top, bottom, left, and right is based on the positional relationship illustrated in the drawings. Furthermore, dimensional ratios of each element are not limited to the illustrated ratio. In the present specification, the numerical range indicated by the expression “to” includes a lower limit value and an upper limit value. That is, the numerical range represented by “x to y” means x or more and y or less.

Materials exemplified in the present specification can be used alone or in combination of two or more kinds thereof unless otherwise specified. The content of each component in a composition means a total amount of a plurality of substances present in the composition, unless otherwise specified, in a case where there are a plurality of substances corresponding to each component in the composition.

An embodiment of a boron nitride powder includes primary particles of hexagonal boron nitride each having a scale shape. The boron nitride powder has an average particle diameter of 4.0 to 7.0 μm, a BET specific surface area of 3.0 m²/g or less, and a graphitization index of 1.2 or less.

An upper limit value of the average particle diameter of the boron nitride powder may be, for example, 6.8 μm or less or 6.6 μm or less. When the upper limit value of the average particle diameter is within the above range, the boron nitride powder is more suitable as a filler material for a small heat-dissipating member. A lower limit value of the average particle diameter of the boron nitride powder may be, for example, 4.4 μm or more, 4.8 μm or more, 5.2 μm or more, or 5.6 μm or more. When the lower limit value of the average particle diameter is within the above range, it is possible to prevent the BET specific surface area from becoming larger than necessary, and the obtained boron nitride powder can exhibit superior filling properties in a resin. The average particle diameter of boron nitride may be adjusted to within the above range, and may be, for example, 4.4 to 7.0 μm or 5.2 to 6.6 μm.

The average particle diameter in the present specification means a 50% cumulative diameter (median diameter) in a volume-based cumulative particle diameter distribution. More specifically, the average particle diameter means a particle diameter (D50) when a cumulative value in a volume-based cumulative particle diameter distribution obtained by a laser diffraction scattering method for a powder reaches 50%. In the laser diffraction scattering method, measurement is performed in accordance with the method described in JIS Z 8825:2013 “Particle diameter analysis-laser diffraction scattering method”. For the measurement, a particle diameter distribution measuring device or the like using a laser diffraction scattering method can be used. As the particle diameter distribution measuring device using a laser diffraction scattering method, for example, “LS-13 320” (product name) manufactured by Beckman Coulter, Inc. or the like can be used. Since the powder to be measured may include an aggregate in which the primary particles are loosely associated with each other, the measurement is performed after the powder to be measured is processed with a homogenizer or the like.

The boron nitride powder according to the present disclosure has a relatively small average particle diameter, but has a relatively smooth outer periphery of a particle shape of primary particles of hexagonal boron nitride each having a scale shape, and has a large thickness, so that the specific surface area is suppressed to be small. An upper limit value of the BET specific surface area of the boron nitride powder is 3.0 m²/g or less, and may be, for example, 2.8 m²/g or less, 2.6 m²/g or less, or 2.5 m²/g or less. When the upper limit value of the BET specific surface area is within the above range, it means that the shape of the primary particles of hexagonal boron nitride is smoother, and an increase in the number of surface functional groups present on side surfaces of the primary particles, which is considered to be a factor of increasing the dielectric loss tangent, is suppressed, and the dielectric loss tangent of the boron nitride powder can be further reduced. A lower limit value of the BET specific surface area of the boron nitride powder may be, for example, 1.0 m²/g or more, 1.3 m²/g or more, or 1.5 m²/g or more. The BET specific surface area of the boron nitride powder may be adjusted within the above range, and may be, for example, 1.3 to 3.0 m²/g, 1.5 to 3.0 m²/g, or 1.5 to 2.5 m²/g.

The specific surface area in the present specification means a value measured by using a specific surface area measuring device in accordance with the description of JIS Z 8830:2013 “Method for measuring specific surface area of powder (solid) by gas adsorption”, and is a value calculated by applying a single point BET method using nitrogen gas. As the specific surface area measuring device, for example, “MONOSORB MS-22 type” (product name) manufactured by QUANTACHROME Instruments can be used.

In the boron nitride powder according to the present disclosure, primary particles of hexagonal boron nitride have high crystallinity. An upper limit value of a graphitization index of the primary particles may be, for example, 1.1 or less or 1.0 or less. Since the primary particles of the hexagonal boron nitride powder in which the upper limit value of the graphitization index is within the above range have a suppressed content of impurities and are excellent in crystallinity, an increase in dielectric loss tangent caused by crystal defects or the like can be further suppressed. A lower limit value of the graphitization index of the primary particles may be, for example, 0.7 or more or 0.8 or more. When the lower limit value of the graphitization index is within the above range, an increase in dielectric loss tangent can be further suppressed. The graphitization index of the primary particles may be adjusted within the above range, and may be, for example, 0.7 to 1.2 or 0.8 to 1.1.

The graphitization index in the present specification is an index value also known as an index value indicating the degree of crystallinity of graphite (for example, J. Thomas, et. al, J. Am. Chem. Soc. 84, 4619 (1962), and the like). The graphitization index is calculated based on a spectrum of the powder containing primary particles of hexagonal boron nitride measured by a powder X-ray diffraction method. First, in an X-ray diffraction spectrum, area values (any unit) surrounded by an integrated intensity (that is, each diffraction peak) of each diffraction peak corresponding to a (100) face, a (101) face, or a (102) face of primary particles of hexagonal boron nitride and a baseline thereof are calculated and designated as S100, S101, and S102, respectively. Using the calculated area value, the graphitization index is determined based on the following formula (1).

$$GI = ( S 100 + S 101 ) / S 102 \qquad Formula ( 1 )$$

The purity of the boron nitride powder may be, for example, 98 mass % or more or 99 mass % or more. When the purity of the hexagonal boron nitride is within the above range, a boron nitride powder having a lower dielectric loss tangent can be obtained.

The purity of the boron nitride powder in the present specification means a value calculated from the following formula (2) based on a measured value obtained by titration. Specifically, first, a powder to be measured is subjected to alkali decomposition with sodium hydroxide, and ammonia is distilled from the decomposition liquid by a steam distillation method and collected in a boric acid aqueous solution. The collected liquid is titrated with a sulfuric acid normal solution. From the result of the titration, a content of nitrogen atoms (N) in the powder is calculated. From the obtained content of nitrogen atoms, a content of hexagonal boron nitride (hBN) in the powder is determined based on the following formula (2), and the purity of the powder is calculated. A formula weight of hexagonal boron nitride is 24.818 g/mol, and an atomic weight of nitrogen atoms is 14.006 g/mol.

$$Content of hexagonal nitride ( hBN ) in sample [ mass \% ] = Content of nitrogen atoms ( N ) [ mass \% ] \times 1.772 \qquad ( 2 )$$

A lower limit value of a tap density of the boron nitride powder may be, for example, 0.70 g/cm³ or more, 0.73 g/cm³ or more, or 0.75 g/cm³ or more. When the lower limit value of the tap density is within the above range, the obtained boron nitride powder can exhibit more excellent filling property in the resin. An upper limit value of the tap density of the boron nitride powder is not particularly limited, and may be, for example, 1.00 g/cm³ or less, 0.98 g/cm³ or less, 0.95 g/cm³ or less, 0.94 g/cm³ or less, or 0.93 g/cm³ or less. The tap density of the boron nitride powder may be adjusted within the above range, and may be, for example, 0.70 to 1.00 g/cm³, 0.73 to 1.00 g/cm³, 0.73 to 0.95 g/cm³, or 0.73 to 0.93 g/cm³.

The tap density in the present specification means a value determined in accordance with the method described in JIS R 1628:1997 “Method for measuring bulk density of fine ceramic powder”, and specifically, is determined by a method described in Examples.

The boron nitride powder described above can be produced, for example, by the following method. An embodiment of the method for producing the powder is a producing method applying a so-called carbon reduction method, including a firing step of firing a raw material powder containing a carbon-containing compound, a boron-containing compound, and a sintering aid under a pressurized nitrogen atmosphere to obtain a fired product containing primary particles of hexagonal boron nitride each having a scale shape; and a pulverization step of crushing the fired product to obtain a powder. A content of the boron-containing compound in the raw material powder is 77.0 mass % or less.

The carbon-containing compound is a compound having a carbon atom as a constituent element. The carbon-containing compound reacts with a boron-containing compound and a compound having a nitrogen atom as a constituent element to form boron nitride. As the carbon-containing compound, a relatively inexpensive raw material having a high purity can be used. Examples of such a carbon-containing compound include carbon black and acetylene black.

The boron-containing compound is a compound having boron as a constituent element. The boron-containing compound is a compound that reacts with a carbon-containing compound and a compound having a nitrogen atom as a constituent element to form boron nitride. As the boron-containing compound, a relatively inexpensive raw material having high purity can be used. Examples of such a boron-containing compound include boric acid and boron oxide. The boron-containing compound preferably contains boric acid. In this case, boric acid is dehydrated by heating to become boron oxide, and can also act as an auxiliary agent that forms a liquid phase and promotes grain growth during a heat treatment of the raw material powder.

The sintering aid forms a liquid phase by reaction with the boron-containing compound or the like, and promotes growth of primary particles of boron nitride. Examples of the sintering aid include oxides and carbonates of alkali metals, and oxides and carbonates of alkaline earth metals. More specific examples of the sintering aid include sodium carbonate, calcium oxide, and calcium carbonate.

In the raw material powder, an excess amount of the boron-containing compound relative to the carbon-containing compound may be blended, but the content of the boron-containing compound in the raw material powder is 77.0 mass % or less. An upper limit value of the content of the boron-containing compound may be, for example, 76.8 mass % or less or 76.5 mass % or less based on the total amount of the raw material powder. When the upper limit value of the content of the boron-containing compound is within the above range, it is possible to suppress an excessive increase in the liquid phase formed by the boron-containing compound and the sintering aid in the firing step, and it is possible to obtain a boron nitride powder more suitable as a filler material in a small heat-dissipating member, such as a thin sheet by suppressing the growth of primary particles of hexagonal boron nitride and suppressing an increase in the average particle diameter. A lower limit value of the content of the boron-containing compound may be, for example, 75.0 mass % or more or 75.3 mass % or more based on the total amount of the raw material powder. When the lower limit value of the content of the boron-containing compound is within the above range, it is possible to more sufficiently reduce a residual carbon content derived from the raw material after firing and to obtain a boron nitride powder having higher purity.

The raw material powder may contain other compounds in addition to the carbon-containing compound, the boron-containing compound, and the sintering aid. Examples of other compounds include boron nitride as a nucleating agent. When the raw material powder contains boron nitride as a nucleating agent, the average particle diameter of the boron nitride powder to be synthesized can be more easily controlled. The raw material powder preferably contains a nucleating agent. In a case where the raw material powder contains a nucleating agent, it is easier to prepare a boron nitride powder having a small specific surface area.

The firing step is performed under a pressurized environment. An upper limit value of the pressure (firing pressure) of an atmosphere in the firing step may be 0.9 MPaG or less or 0.8 MPaG or less. By setting a pressure condition in the firing step within the above range and relaxing the degree of pressurization, it is possible to volatilize a liquid phase to the outside of a system during the firing step, to suppress the growth of primary particles of hexagonal boron nitride in an a-axis direction, and to further suppress the increase in the average particle diameter. A lower limit value of the pressure of the atmosphere in the firing step may be, for example, 0.5 MPaG or more, 0.6 MPaG or more, or 0.7 MPaG or more. By setting the lower limit value of the pressure of the atmosphere within the above range, volatilization of the boron-containing compound is suppressed, and the liquid phase of the boron-containing compound is maintained, whereby the crystallinity of the primary particles of hexagonal boron nitride can be further enhanced. The pressure of the atmosphere in the firing step may be adjusted within the above range, and may be, for example, 0.5 to 0.9 MPaG. The pressure in the present specification means gauge pressure.

The firing temperature in the firing step is, for example, 1800° C. to 2200° C. An upper limit value of the firing temperature may be, for example, 2150° C. or lower or 2100° C. or lower. By setting the upper limit value of the firing temperature within the above range, the generation of by-products can be sufficiently suppressed. A lower limit value of the firing temperature may be, for example, 1850° C. or higher, 1900° C. or higher, 1950° C. or higher, 2000° C. or higher, or 2050° C. or higher. By setting the lower limit value of the firing temperature within the above range, a reaction on the carbon-containing compound can be promoted, and the yield of the obtained boron nitride can be further improved.

The lower limit value of retention time in the firing step may be, for example, 7 hours or more, or 8 hours or more. By setting the lower limit value of the retention time within the above range, the thickness of the primary particles of hexagonal boron nitride is increased, the orientation between the primary particles is further reduced, and a boron nitride powder having a higher tap density can be prepared. An upper limit value of the retention time in the firing step is not particularly limited, and may be, for example, 20 hours or less, 18 hours or less, 16 hours or less, 14 hours or less, or 12 hours or less from the viewpoint of reducing the manufacturing cost of the boron nitride powder. The retention time in the firing step may be adjusted within the above range, and may be, for example, 7 to 20 hours or 7 to 12 hours.

In the pulverization step, the fired product obtained in the firing step is crushed to obtain a boron nitride powder. In the crushing step, for example, a crusher such as a Henschel mixer or a grinder mill can be used.

The boron nitride powder described above can be suitably used as a heat-dissipating filler because it has excellent filling property with respect to a resin and can also suppress the orientation of primary particles in a resin molded sheet. An embodiment of the heat-dissipating sheet is a heat-dissipating sheet including a resin and a heat-dissipating filler dispersed in the resin. The heat-dissipating filler contains the boron nitride powder described above.

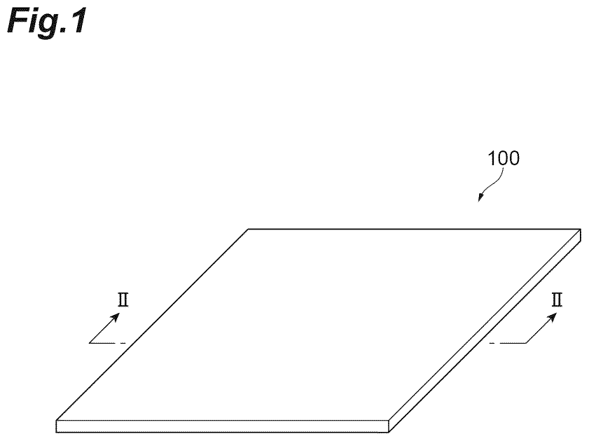

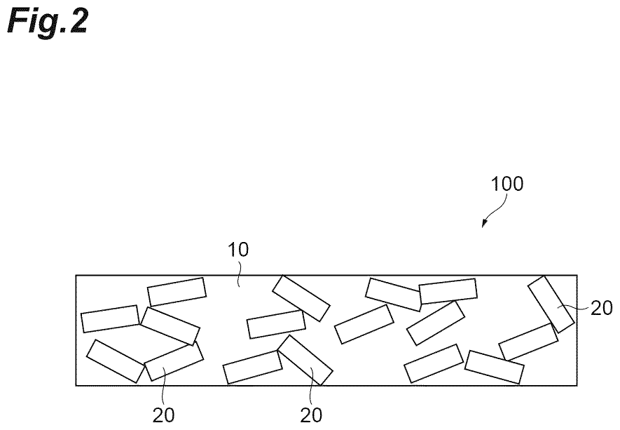

FIG. 1 is a schematic view illustrating an example of a heat-dissipating sheet. FIG. 2 is a cross-sectional view taken along line II-II of FIG. 1. A heat-dissipating sheet 100 includes a resin portion 10 and a plurality of primary particles 20 of hexagonal boron nitride with which the resin portion 10 is filled. In the heat-dissipating sheet 100, since the primary particles 20 have a relatively large thickness, a main surface of the heat-dissipating sheet 100 and a-axes of the primary particles are not parallel to each other, and are maintained in an appropriately inclined state. As a result, sufficient heat dissipation can be exhibited also in a thickness direction of the heat-dissipating sheet 100.

A lower limit value of the content of the boron nitride powder in the heat-dissipating sheet may be, for example, 30 vol % or more, 40 vol % or more, or 50 vol % or more based on a total volume of the heat-dissipating sheet. When the lower limit value of the content of the boron nitride powder is within the above range, the heat dissipation of the heat-dissipating sheet can be further improved. An upper limit value of the content of the boron nitride powder in the heat-dissipating sheet may be, for example, 85 vol % or less, 80 vol % or less, 75 vol % or less, or 70 vol % or less based on the total volume of the heat-dissipating sheet. When the upper limit value of the content of the boron nitride powder is within the above range, generation of voids inside the heat-dissipating sheet can be further suppressed when the heat-dissipating sheet is molded, and insulating properties and mechanical strength can be prevented from being lowered.

The resin portion 2 may contain a cured resin or may be made of a cured resin. Examples of the type of the cured resin constituting the resin portion 2 include an epoxy resin, a phenol resin, a melamine resin, a urea resin, polyimide, polyamideimide, polyetherimide, and a maleimide-modified resin.

A lower limit value of the content of the cured resin in the heat-dissipating sheet may be, for example, 15 vol % or more, 20 vol % or more, or 30 vol % or more based on the total volume of the heat-dissipating sheet. An upper limit value of the content of the cured resin in the heat-dissipating sheet may be, for example, 70 vol % or less, 60 vol % or less, or 50 vol % or less based on the total volume of the heat-dissipating sheet.

The heat-dissipating sheet described above can be prepared by, for example, subjecting a resin composition containing a boron nitride powder containing primary particles of hexagonal boron nitride each having a scale shape and a thermosetting resin to heat-and-pressure molding or the like. The resin composition may contain other components, for example, a curing agent or the like. The curing agent may be appropriately selected depending on the type of thermosetting resin. For example, in a case where the resin is an epoxy resin, examples of the curing agent include a phenol novolak compound, an acid anhydride, an amino compound, and an imidazole compound. A lower limit value of the content of the curing agent may be, for example, 0.5 parts by mass or more or 1.0 part by mass or more with respect to 100 parts by mass of the resin. An upper limit value of the content of the curing agent may be, for example, 15 parts by mass or less or 10 parts by mass or less with respect to 100 parts by mass of the resin.

Since the boron nitride powder described above is mainly composed of primary particles of hexagonal boron nitride, it can be used in combination with other heat-dissipating fillers. The heat-dissipating filler may further contain, for example, aluminum nitride or the like in addition to the boron nitride powder described above. In a case of a powder composed of hexagonal boron nitride and mainly composed of agglomerated particles formed by agglomerating a plurality of primary particles, when the powder is used in combination with other heat-dissipating fillers, the agglomerates may collapse due to collision between the fillers or the like at the time of kneading with the resin, so that the assumed performance may not be exhibited in some cases, and control of kneading conditions or the like is required.

Although some embodiments have been described above, the present disclosure is not limited to the above embodiments at all. Furthermore, the description contents of the above-described embodiments can be applied to each other.

### EXAMPLES

Hereinafter, the present disclosure will be described in more detail using Examples and Comparative Examples. Note that the present disclosure is not limited to the following examples.

### Example 1

### [Preparation of Hexagonal Boron Nitride Powder]

Acetylene black (Manufactured by Denka Company Limited, grade name: Li400), boric acid (manufactured by Kojundo Chemical Laboratory Co., Ltd.), and sodium carbonate (purity of 99.5% or more) were mixed by a Henschel mixer to obtain a mixed powder (raw material powder). In this case, boric acid was blended in the raw material powder such that a content thereof is 76.9 mass %. The obtained mixed powder was placed in a dryer at 250° C. and held for 3 hours to dehydrate boric acid. The dehydrated mixed powder was placed in a die having a diameter of 100 Φ of a press molding machine, and molded under the conditions of a heating temperature of 200° C. and a press pressure of 30 MPa. Pellets of the raw material powder thus obtained were subjected to the subsequent heat treatment.

First, pellets of the raw material powder were allowed to stand in a carbon atmosphere furnace, and heated to 1900° C. at a temperature rising rate of 5° C./min in a nitrogen atmosphere pressurized to 0.5 MPaG, and held at 1900° C. for 8 hours to perform a heat treatment of the pellets, thereby obtaining a fired product (firing step).

The obtained fired product was crushed by a Henschel mixer to prepare a powder (pulverization step). In this manner, a boron nitride powder was prepared.

### <Measurement of Physical Properties of Boron Nitride Powder>

For the obtained hexagonal boron nitride powder, an average particle diameter, a BET specific surface area, a graphitization index, and a tap density were measured according to the method described later. The results are shown in Table 1.

### [Average Particle Diameter]

The average particle diameter of primary particles in the boron nitride powder was measured using a particle diameter distribution measuring device using a laser diffraction scattering method (manufactured by Beckman Coulter, Inc., trade name: LS-13 320) in accordance with the description of ISO 13320:2009. In the measurement of the hexagonal boron nitride powder, a dispersion of the hexagonal boron nitride powder was prepared by performing ultrasonic dispersion once in 1 minute and 30 seconds with AMPLITUDE (amplitude) 80% using an ultrasonic homogenizer (manufactured by Nippon Seiki Seisakusho Co., Ltd., trade name: US-300E), and the dispersion was used as an object to be measured. When measuring the particle diameter distribution, water was used as a solvent for dispersing the hexagonal boron nitride powder, and hexametaphosphoric acid was used as a dispersant. In this case, a numerical value of 1.33 was used as a refractive index of water, and a numerical value of 1.80 was used as a refractive index of the boron nitride powder.

### [Specific Surface Area]

The specific surface area of the boron nitride powder was calculated in accordance with the description of JIS Z 8830:2013 “Method for measuring specific surface area of powder (solid) by gas adsorption” by applying the single point BET method using nitrogen gas. As a specific surface area measuring device, a specific surface area measuring device (device name: MONOSORB MS-22 type) manufactured by Quantachrome Instruments was used. The measurement was performed after the boron nitride powder was dried and degassed at 300° C. over 15 minutes.

### [Graphitization Index]

The graphitization index of the boron nitride powder was calculated from the measurement result by powder X-ray diffraction. In the obtained X-ray diffraction spectrum, area values (any unit) surrounded by an integrated intensity (that is, each diffraction peak) of each diffraction peak corresponding to a (100) face, a (101) face, or a (102) face of primary particles of hexagonal boron nitride and a baseline thereof were calculated and designated as S100, S101, and S102, respectively. Using the area value thus calculated, the graphitization index was determined based on the following formula (1).

$$GI = ( S 100 + S 101 ) / S 102 \qquad ( 1 )$$

### [Tap Density]

The tap density of the boron nitride powder was measured in accordance with the method described in JIS R 1628:1997 “Method for measuring bulk density of fine ceramic powder”. Specifically, a dedicated container of 100 cm³ was filled with a boron nitride powder, and a bulk density after tapping under the conditions of a tapping time of 180 seconds, a tapping number of 180 times, and a tap lift of 18 mm was measured by “Powder Tester” manufactured by Hosokawa Micron Corporation, and the obtained value was taken as the tap density.

### Example 2

A boron nitride powder was prepared in the same manner as in Example 1 except that the firing temperature was changed to 2000° C. and the firing pressure was changed to 0.7 MPaG. For the obtained boron nitride powder, an average particle diameter, a BET specific surface area, a graphitization index, and a tap density were measured in the same manner as in Example 1. The results are shown in Table 1.

### Example 3

A boron nitride powder was prepared in the same manner as in Example 1 except that the firing temperature was changed to 2000° C. and the firing pressure was changed to 0.9 MPaG. For the obtained boron nitride powder, an average particle diameter, a BET specific surface area, a graphitization index, and a tap density were measured in the same manner as in Example 1. The results are shown in Table 1.

### Example 4

A boron nitride powder was prepared in the same manner as in Example 1 except that the firing pressure was changed to 0.9 MPaG. For the obtained boron nitride powder, an average particle diameter, a BET specific surface area, a graphitization index, and a tap density were measured in the same manner as in Example 1. The results are shown in Table 1.

### Comparative Example 1

100 parts by mass of a boric acid powder (purity: 99.8 mass % or more, manufactured by KANTO CHEMICAL CO., INC.), 9 parts by mass of a melamine powder (purity: 99.0 mass % or more, manufactured by FUJIFILM Wako Pure Chemical Corporation), and 13 parts by mass of sodium carbonate (purity of 99.5 mass % or more) as a sintering aid were added, and mixed for 10 minutes using an alumina mortar to obtain a mixed powder. A dried mixed powder was placed in a container made of hexagonal boron nitride and placed in an electric furnace. The temperature was raised from room temperature to 1000° C. while circulating nitrogen gas in the electric furnace. After holding at 1000° C. for 2 hours, heating was stopped and natural cooling was performed. In this manner, a calcined product containing low crystalline boron nitride was obtained.

100 g of the calcined product was disposed in the electric furnace. The temperature was raised to 1700° C. while circulating the nitrogen gas in the electric furnace. After holding at a firing temperature of 1700° C. for 4 hours, heating was stopped and natural cooling was performed. The obtained fired product was recovered and pulverized in an alumina mortar for 10 minutes to obtain a powder. The powder was used as a boron nitride powder of Comparative Example 1.

For the obtained boron nitride powder, an average particle diameter, a BET specific surface area, a graphitization index, and a tap density were measured in the same manner as in Example 1. The results are shown in Table 1.

### Comparative Example 2

A boron nitride powder was prepared in the same manner as in Comparative Example 1 except that the firing temperature was changed to 1800° C. For the obtained boron nitride powder, an average particle diameter, a BET specific surface area, a graphitization index, and a tap density were measured in the same manner as in Example 1. The results are shown in Table 1.

### Comparative Example 3

A boron nitride powder was prepared in the same manner as in Comparative Example 1 except that calcium carbonate was used instead of sodium carbonate and the retention time was changed to 8 hours. For the obtained boron nitride powder, an average particle diameter, a BET specific surface area, a graphitization index, and a tap density were measured in the same manner as in Example 1. The results are shown in Table 1.

### <Evaluation of Boron Nitride Powder as Filler Material>

The dielectric loss tangent of the obtained boron nitride powder when used as a filler material in a resin was measured. Specifically, the dielectric loss tangent of the boron nitride powder at 1 GHz was determined by performing measurement under the condition of a temperature of 25° C. using a measuring device of a cavity resonator method (measurement system manufactured by Keycomb Corporation, perturbation method, cavity resonator type DPS18). From the value of the obtained dielectric loss tangent, evaluation was performed according to the following criteria. The results are shown in Table 1.
A: The dielectric loss tangent is 0.0007 or less.
B: The dielectric loss tangent is more than 0.0007 and 0.0012 or less.
C: The dielectric loss tangent is more than 0.0012 and 0.0016 or less.
D: The dielectric loss tangent is more than 0.0016.

TABLE 1

| | | Example | Example | Example | Example | Comparative | Comparative | Comparative |
|---|---|---|---|---|---|---|---|---|
| | | 1 | 2 | 3 | 4 | Example 1 | Example 2 | Example 3 |
| Powder | Average particle diameter [μm] | 4.4 | 6.8 | 6.5 | 5.8 | 3.6 | 7.8 | 17.1 |
| | BET specific surface area [m²/g] | 3.0 | 2.7 | 2.2 | 2.5 | 11.0 | 5.7 | 2.8 |
| | Graphitization index | 1.2 | 1.2 | 1.0 | 1.1 | 1.3 | 1.1 | 1.4 |
| | Tap density [g/cm³] | 0.73 | 0.76 | 0.74 | 0.71 | 0.34 | 0.52 | 0.75 |
| Evaluation | Dielectric loss tangent | B | B | A | A | D | D | C |

### INDUSTRIAL APPLICABILITY

According to the present disclosure, it is possible to provide a boron nitride powder having a low dielectric loss tangent and an excellent filling property in a resin, and a method for producing the same. According to the present disclosure, it is also possible to provide a heat-dissipating sheet including the boron nitride powder described above.

### REFERENCE SIGNS LIST

10 Resin portion
20 Primary particle
100 Heat-dissipating sheet

1. A boron nitride powder comprising:
primary particles of hexagonal boron nitride each having a scale shape,
wherein an average particle diameter is 4.0 to 7.0 μm, a BET specific surface area is 3.0 m²/g or less, and a graphitization index is 1.2 or less.

2. The boron nitride powder according to claim 1, wherein a tap density is 0.70 g/cm³ or more.

3. A heat-dissipating sheet comprising:
a resin; and a filler dispersed in the resin,
wherein the filler comprises the boron nitride powder according to claim 1.

4. A method for producing a boron nitride powder, comprising:
a firing step of firing a raw material powder comprising a carbon-containing compound, a boron-containing compound, and a sintering aid under a pressurized nitrogen atmosphere to obtain a fired product containing primary particles of hexagonal boron nitride each having a scale shape; and
a pulverization step of crushing the fired product to obtain a powder,
wherein a content of the boron-containing compound in the raw material powder is 77.0 mass % or less.

5. The producing method according to claim 4, wherein a pressure of the atmosphere in the firing step is 0.9 MPaG or less.

6. A heat-dissipating sheet comprising:
a resin; and a filler dispersed in the resin,
wherein the filler comprises the boron nitride powder according to claim 2.
